(19) United States
(12) Patent Application Publication
(10) Pub. No.: US 2026/0061346 A1
(43) Pub. Date: Mar. 5, 2026

(54) FILTER UNIT

(71) Applicant: CAWARE FILTERING CORPORATION, KAOHSIUNG CITY (TW)

(72) Inventor: MIN-HUA CHANG, KAOHSIUNG CITY (TW)

(21) Appl. No.: 18/897,531

(22) Filed: Sep. 26, 2024

(30) Foreign Application Priority Data
Aug. 29, 2024 (TW) 113132556

(51) Int. Cl. B01D 27/08

(52) U.S. Cl. CPC B01D 27/08; B01D 2201/0415; B01D 2201/304

(57) ABSTRACT

A filter unit has a filter cartridge and a rotary filter holder assembly detachably mounted to the filter cartridge. The rotary filter holder assembly has an annular check valve configured to be rotate relative to a filter holder to a closed position and an opened position. When the annular check valve is at the closed position, the inlet channel of the filter holder is sealed by a sealing pad of the annular check valve, and the outlet channel of the filter holder is closed by a top of a base of the annular check valve, thereby preventing fluid in the inlet channel and the outlet channel from leaking.

### BACKGROUND OF THE INVENTION

### 1. Field of the Invention

The present invention relates to a filter device, and more particularly to a filter unit that is configured to be rotated to open or close an inlet channel and an outlet channel in a filter holder at the same time.

### 2. Description of Related Art

A conventional filter unit substantially comprises a filter holder and a filter cartridge. The filter cartridge is detachably connected to the filter holder. The filter holder has an inlet channel and an outlet channel formed therein and fluidly communicating with the filter cartridge. Water from an external water source may flow into the conventional filter unit via the inlet channel in the filter holder, flows through the filter cartridge to be filtered by the filter cartridge, and flows out from the conventional filter unit via the outlet channel in the filter holder.

The conventional filter unit further comprises a valve seat and a floating check-ball mounted in the filter holder and located between the filter cartridge and the outlet channel in the filter holder. While the fluid continuously flowing into the conventional filter unit to be filtered, the flow pressure of the fluid causes the floating check-ball to be pushed away from the valve seat to open the valve seat, so the filtered fluid is able to flow out from the filter cartridge. When the filter cartridge is detached from the filter holder, the floating check-ball is able to fall down to close the valve seat due to gravity, thereby preventing the fluid remaining in the outlet channel of the filter holder from flowing reversely out of the filter holder. Since the valve seat and the floating check-ball are disposed between the outlet channel of the filter holder and the filter cartridge, the fluid remaining inside the inlet channel is prone to drip from the filter holder when the filter cartridge is removed from the filter holder. Further to this, it is difficult to assemble the structure of the valve seat and the floating check-ball. Reliability of closing the valve seat by the floating check-ball is poor, and the fluid remaining in the outlet channel may still drip from the valve seat.

Another conventional filter unit comprises a check valve disposed in the outlet channel of the filter holder. The check valve includes a valve ball and a spring configured for pushing the valve ball to close the outlet channel in the filter holder. However, the valve ball and the spring are both made of a metallic material, are easily oxidized if soaked in liquid for a long time to pollute the fluid. Reliability of closing the outlet channel via the valve ball pushed by the spring is also poor. In addition, the check valve is only disposed in the outlet channel of the filter holder, after removing the filter cartridge from the filter holder, the fluid remaining inside the inlet channel is prone to drip from the filter holder.

To overcome the shortcomings, the present invention tends to provide a filter unit to mitigate or obviate the aforementioned problems.

### SUMMARY OF THE INVENTION

The main objective of the invention is to provide a filter unit that is configured to open or close an outlet channel and an inlet channel at the same time by a rotating operation.

A filter unit comprises a filter cartridge and rotary filter holder assembly detachably mounted to a top portion of the filter cartridge. The rotary filter holder assembly comprises an annular check valve and a filter holder. The annular check valve is disposed on the top portion of the filter cartridge, is configured to be rotated with the filter cartridge, and comprises a base disposed on the top portion of the filter cartridge and configured to be rotated with the filter cartridge, a neck part extending from a top of the base, an inlet opening formed in the neck part and fluidly communicating with the filter cartridge, an outlet opening formed in the top of the base and fluidly communicating with the filter cartridge, and a sealing pad disposed at a periphery of the neck part and spaced apart from the inlet opening by an angular interval. The filter holder is disposed on, surrounds, and is rotatably connected to the annular check valve, and comprises an inlet channel and an outlet channel. The annular check valve is configured to be rotated relative to the filter holder to a closed position and an opened position. When the annular check valve is located at the closed position, the inlet channel of the filter holder is sealed by the sealing pad and the outlet channel of the filter holder is closed by the top of the base. When the annular check valve is located at the opened position, the inlet channel of the filter holder fluidly communicates with the inlet opening of the annular check valve and the outlet channel of the filter holder fluidly communicates with the outlet opening of the annular check valve.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a filter unit in accordance with the present invention;

FIG. 2 is an exploded perspective view of the filter unit in FIG. 1;

FIG. 3 is an exploded perspective view of a rotary filter holder assembly of the filter unit in FIG. 2;

FIG. 4 is another exploded perspective view of the rotary filter holder assembly of the filter unit in FIG. 1;

FIG. 5 is an exploded perspective view of an annular check valve of the rotary filter holder assembly in FIG. 3;

FIG. 6 is an enlarged cross-sectional side view of the filter unit in FIG. 1 showing that the annular check valve is located at a closed position;

FIG. 7 is an enlarged cross-sectional side view of the filter unit in FIG. 1 showing that the annular check valve is located at an opened position;

FIG. 8 is a cross-sectional top view of the filter unit in FIG. 1 showing that the annular check valve is located at the closed position;

FIG. 9 is a top view of the filter unit in FIG. 1 showing that the annular check valve is located at the closed position, wherein a filter holder is omitted;

FIG. 10 is a cross-sectional top view of the filter unit in FIG. 1 showing that the annular check valve is located at the opened position;

FIG. 11 is a top view of the filter unit in FIG. 1 showing that the annular check valve is located at the opened position, wherein the filter holder is omitted;

FIG. 12 is a cross-sectional top view of the filter unit in FIG. 1;

FIG. 13 is an enlarged cross-sectional side view of a second embodiment of a filter unit in accordance with the present invention; and

FIG. 14 is an enlarged cross-sectional side view of a third embodiment of a filter unit in accordance with the present invention.

### DETAILED DESCRIPTION OF PREFERRED EMBODIMENT S

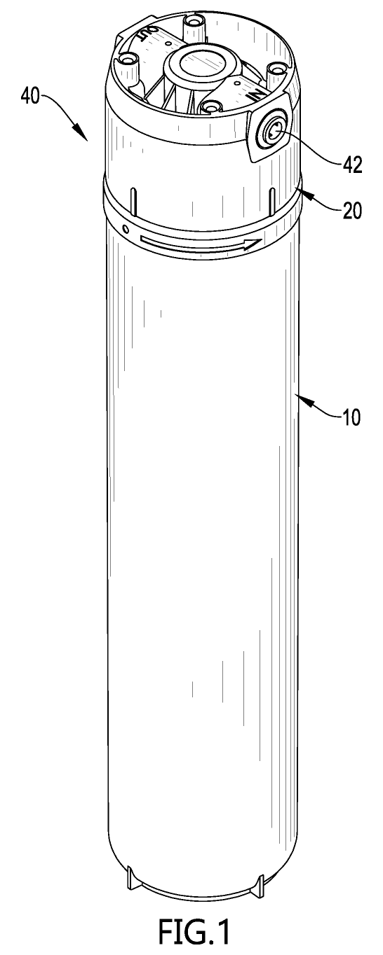

With reference to FIGS. 1 to 4, a first embodiment of a filter unit in accordance with the present invention comprises a filter cartridge 10 and a rotary filter holder assembly 20. The rotary filter holder assembly 20 is detachably mounted to a top portion of the filter cartridge 10 and comprises an annular check valve 30 and a filter holder 40.

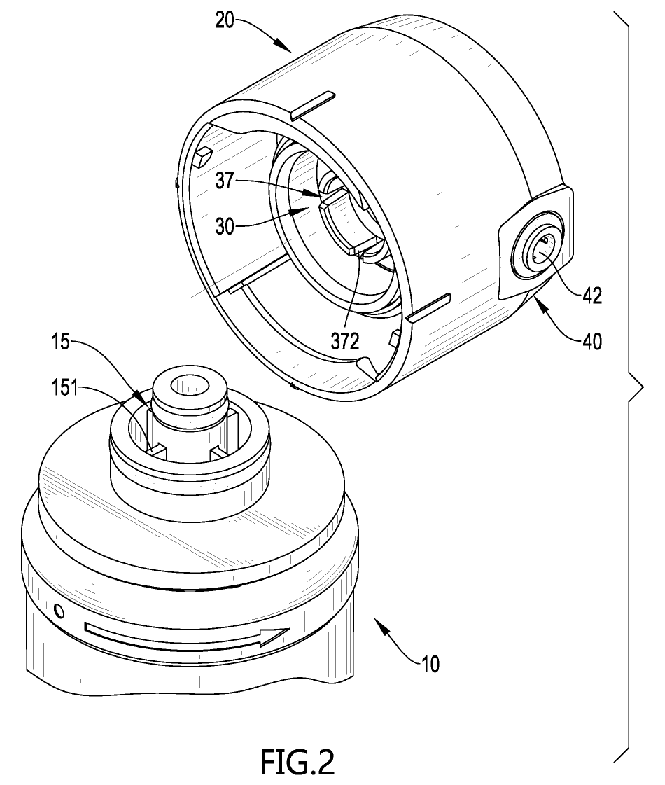

With reference to FIGS. 2 to 6, the annular check valve 30 is disposed on the top portion of the filter cartridge 10 and is configured to be rotated with the filter cartridge 10. The annular check valve 30 comprises a base 31, a neck part 33, an inlet opening 32, an outlet opening 34, and a sealing pad 35. The base 31 is disposed on the top portion of the filter cartridge 10 and is configured to be rotated with the filter cartridge 10. The neck part 33 extends upwardly from a top of the base 31. The inlet opening 32 is formed in the neck part 33 and fluidly communicates with the filter cartridge 10. The outlet opening 34 is formed in the top of the base 31 and fluidly communicates with the filter cartridge 10. The sealing pad 35 is disposed to a periphery of the neck part 33 and is spaced apart from the inlet opening 32 by an angular interval.

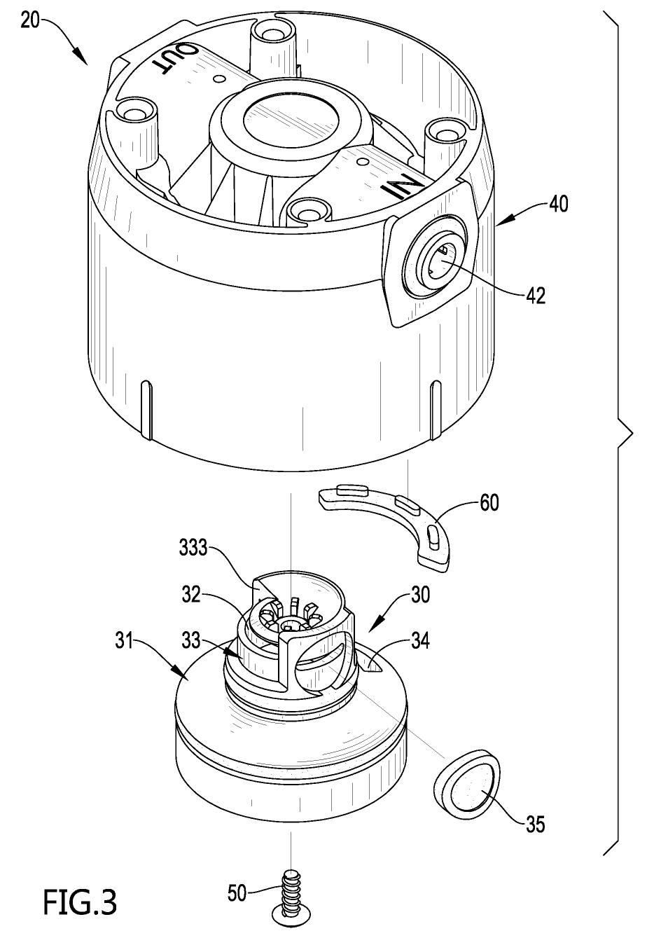

With reference to FIGS. 3, 4, 6, and 7, the filter holder 40 is disposed on, surrounds, and is rotatably connected to the annular check valve 30. The filter holder 40 comprises an inlet channel 42 and an outlet channel 44.

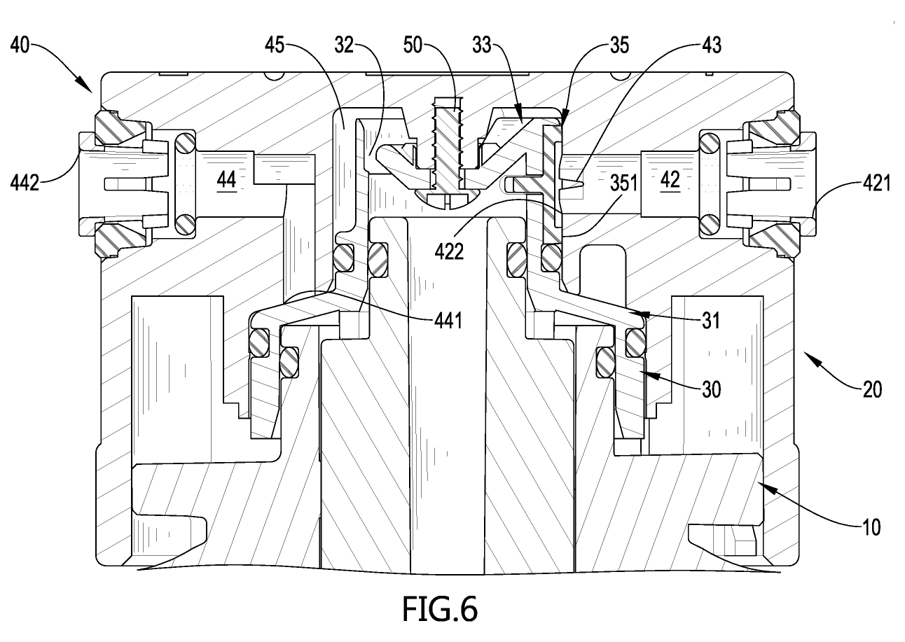

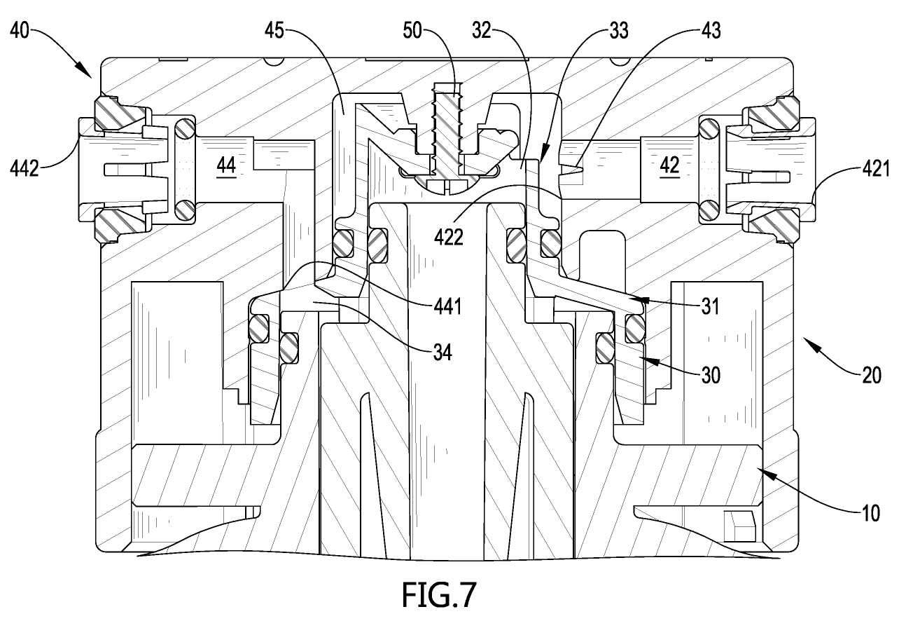

The annular check valve 30 is configured to be rotated relative to the filter holder 40 to a closed position as shown in FIGS. 6, 8, and 9 and to an opened position as shown in FIGS. 7, 10, and 11.

As shown in FIG. 6, when the annular check valve 30 is located at the closed position, the inlet channel 42 of the filter holder 40 is sealed by the sealing pad 35, and the outlet channel 44 of the filter holder 40 is closed by the top of the base 31. Therefore, fluid remaining in the inlet channel 42 and the outlet channel 44 cannot drip out of the filter holder 40.

As shown in FIG. 7, when the annular check valve 30 is located at the opened position, the inlet channel 42 of the filter holder 40 fluidly communicates with the inlet opening 32 of the annular check valve 30, and the outlet channel 44 of the filter holder 40 fluidly communicates with the outlet opening 34 of the annular check valve 30. Therefore, fluid from an external water source is able to sequentially flow through the inlet channel 42 of the filter holder 40, the inlet opening 32 of the annular check valve 30, and into the filter cartridge 10 to be filtered by the filter cartridge 10. The filtered fluid is able to flow out of the filter unit from the filter cartridge 10 through the outlet opening 34 of the annular check valve 30 and the outlet channel 44 of the filter holder 40 in sequence.

With reference to FIGS. 3, 4, 6, and 7, the filter holder 40 comprises a mounting chamber 45 extending upwardly from a bottom of the filter holder 40. The inlet channel 42 of the filter holder 40 fluidly communicates with the mounting chamber 45. The inlet channel 42 radially extends from an external peripheral surface of the filter holder 40 to the mounting chamber 45 and forms an inlet port 421 at the external peripheral surface of the filter holder 40 and an outlet port 422 fluidly communicating with the mounting chamber 45. The neck part 33 of the annular check valve 30 extends into the mounting chamber 45 and tightly seals the mounting chamber 45. The inlet opening 32 of the annular check valve 30 fluidly communicates with the mounting chamber 45. The outlet channel 44 is disposed outside of and spaced apart from the mounting chamber 45. The outlet channel 44 extends upwardly from the bottom of the filter holder 40 and then extends radially to the external peripheral surface of the filter holder 40 as an inverted-L shape. The outlet channel 44 has an inlet port 441 and an outlet port 442. The inlet port 441 faces toward the top of the base 31 of the annular check valve 30 and fluidly communicates with the outlet opening 34 of the annular check valve 30 selectively. The outlet port 442 is formed in the external peripheral surface of the filter holder 40.

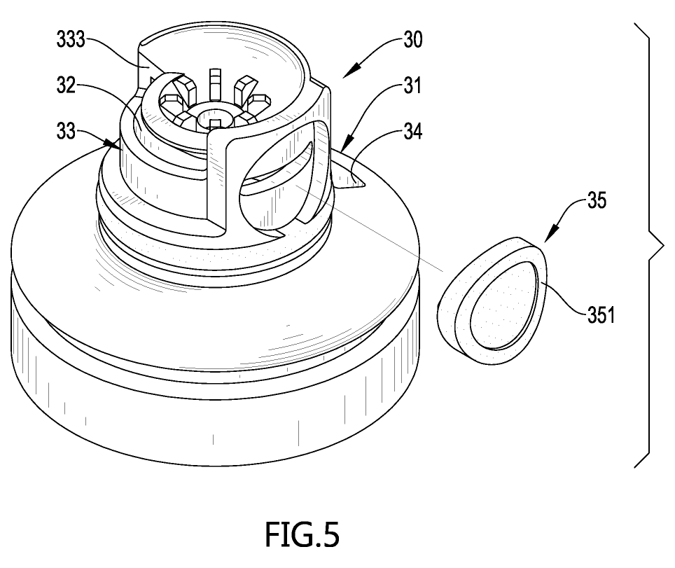

With reference to FIGS. 5 and 6, the sealing pad 35 may be made of elastomers, e.g. silicone or rubber, is fixed to the neck part 33, and tightly abuts against a peripheral surface of the mounting chamber 45. When the annular check valve 30 is located at the closed position, the sealing pad 35 tightly abuts against the peripheral surface of the mounting chamber 45 and seals the outlet port 422 of the inlet channel 42 of the filter holder 40 to prevent the fluid remaining in the inlet channel 42 from flowing into the mounting chamber 45. The sealing pad 35 has an annular protrusion 351 formed at a side of the sealing pad 35 facing toward the peripheral surface of the mounting chamber 45. The annular protrusion 351 is configured to surround the outlet port 422 of the inlet channel 42 facing toward the mounting chamber 45 when the annular check valve 30 is rotated to the closed position.

With reference to FIGS. 6 and 7, a guiding rib 43 is disposed in the outlet port 422 of the inlet channel 42 and has two ends extending to and connected to a periphery of the inlet channel 42. The guiding rib 43 has a top surface inclined downwardly toward the external peripheral surface of the filter holder 40 and a bottom surface inclined upwardly toward the external peripheral surface of the filter holder 40. The guiding rib 43 has a triangular section. The guiding rib 43 is configured to guide the flow direction to avoid energy loss caused by turbulent. A side of the guiding rib 43 facing toward the mounting chamber 45 is configured to support the sealing pad 35, thereby preventing the sealing pad 35 from deforming and partially inserted into the inlet channel 42 during rotation of the annular check valve 30 relative to the filter holder 40.

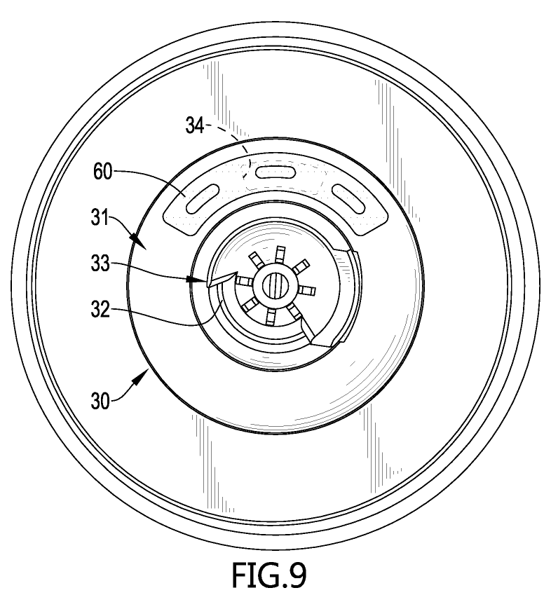

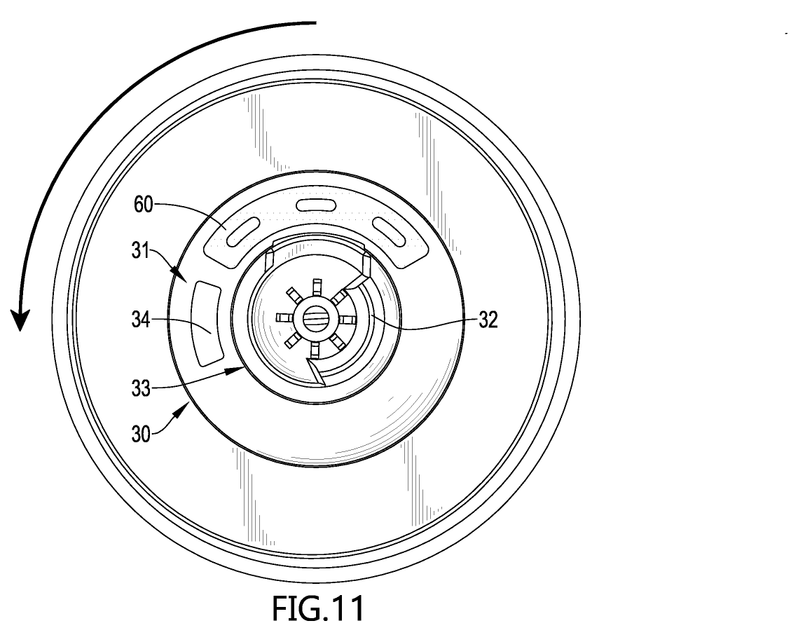

With reference to FIGS. 3, 4, 9, and 11, the rotary filter holder assembly 20 further comprises a closing pad 60. The closing pad 60 may be made of elastomers, e.g. silicone or rubber, and is fixed to the bottom of the filter holder 40. With reference to FIGS. 6 and 9, when the annular check valve 30 is located at the closed position, the outlet opening 34 of the annular check valve 30 is located directly below the closing pad 60 and is sealed by the closing pad 60, thereby preventing the fluid remaining in the outlet channel 44 of the filter holder 40 from flowing reversely into the outlet opening 34. With reference to FIGS. 7 and 11, when the annular check valve 30 is rotated to the opened position, the outlet opening 34 of the annular check valve 30 is moved away from the closing pad 60 to be opened and is moved to a position to fluidly communicate with the outlet channel 44. Therefore the fluid filtered by the filter cartridge 10 is able to pass the outlet opening 34 of the annular check valve 30 and enter into the outlet channel 44.

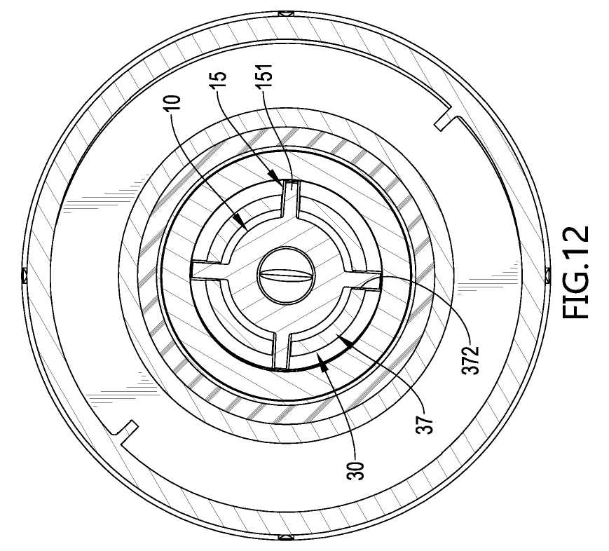

With reference to FIGS. 2, 4, and 12, the top portion of the filter cartridge 10 has a blocking portion 15. The annular check valve 30 has an engagement portion 37 at the bottom of the base 31 and engaging with the blocking portion 15 to fix the annular check valve 30 on the filter cartridge 10, so the annular check valve 30 is capable of rotating with the filter cartridge 10. Specifically, the blocking portion 15 includes multiple blocking ribs 151 arranged at angular intervals. The engagement portion 37 includes multiple engaging notches 372 arranged at angular intervals to receive the multiple blocking ribs 151. The blocking ribs 151 respectively extend into and engage with the engaging notches 372 to fix the orientation of the annular check valve 30 and the filter cartridge 10, whereby the annular check valve 30 is capable of rotating with the filter cartridge 10.

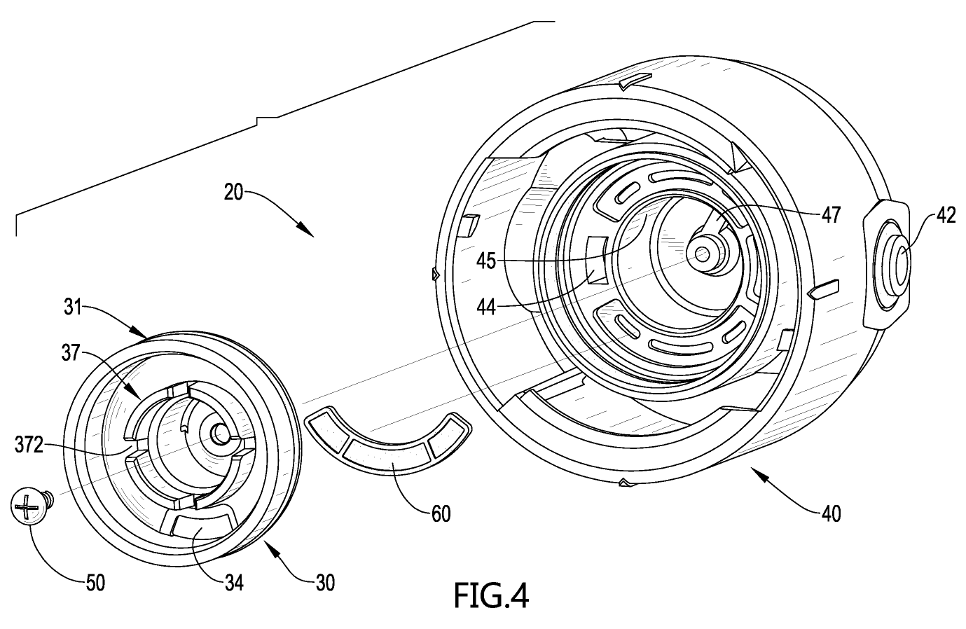

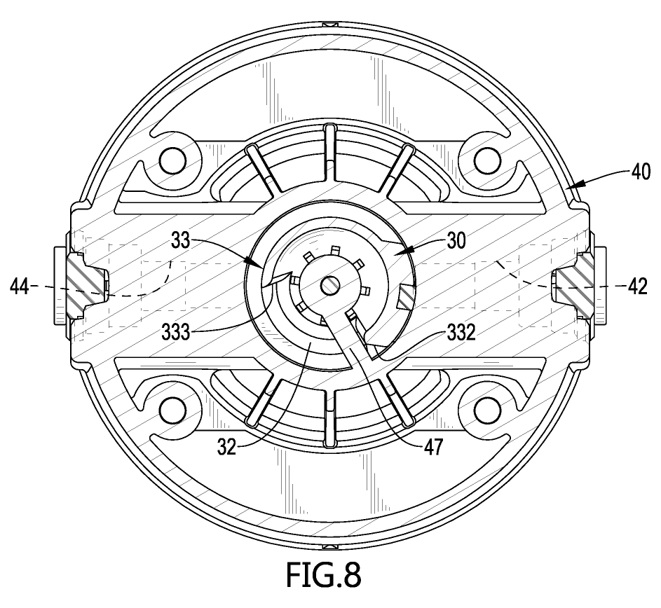

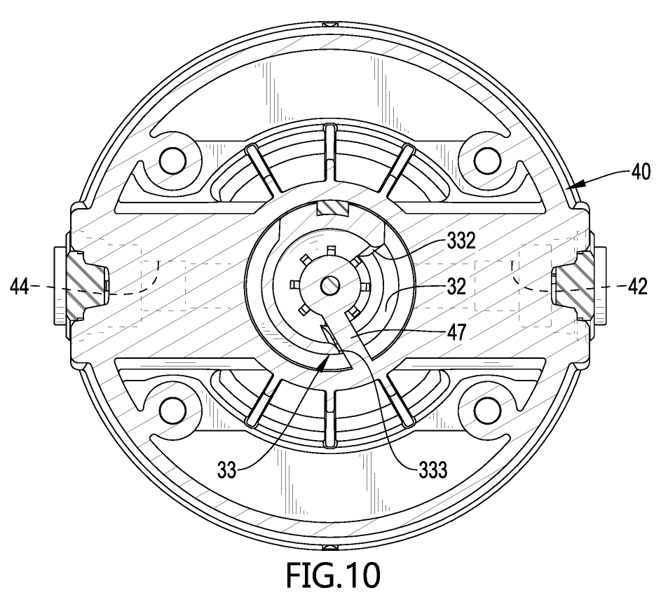

With reference to FIGS. 4, 5, 8, and 10, the neck part 33 of the annular check valve 30 has a first limited surface 332 and a second limited surface 333 arranged at an angular interval. The filter holder 40 comprises a limiting block 47 configured to abut against the first limited surface 332 or the second limited surface 333. As shown in FIG. 8, when the limiting block 47 abuts against the first limited surface 332, the annular check valve 30 is located at the closed position. As shown in FIG. 10, when the limiting block 47 abuts against the second limited surface 333, the annular check valve 30 is located at the opened position. A rotatable angle of the annular check valve 30 relative to the filter holder 40 can be limited by blocking the first limited surface 332 and the second limited surface 333 via the limiting block 47, and therefore the annular check valve 30 is limited at the closed position or the opened position.

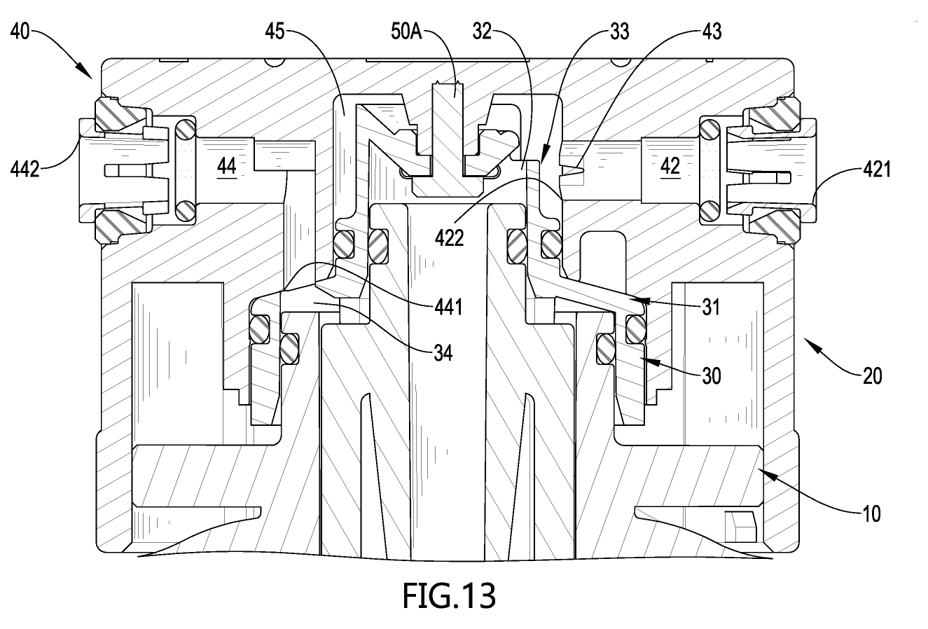

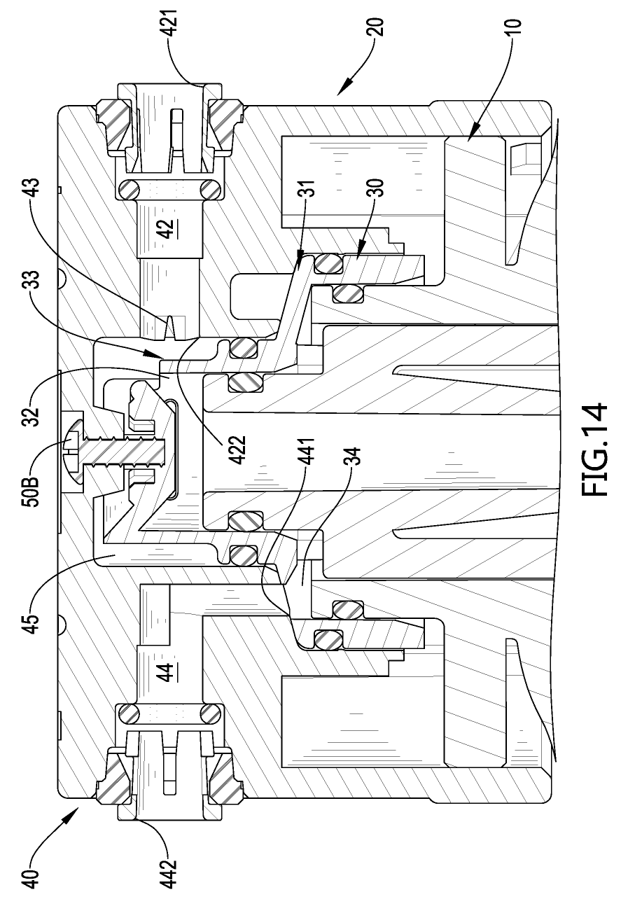

With reference to FIGS. 4, 6, and 7, the annular check valve 30 is connected to the filter holder 40 via a shaft 50 and is rotatable relative to the filter holder 40 along the shaft 50. In the first embodiment, the shaft 50 is made of a non-metallic material, has a thread spirally around the shaft 50, is mounted through the annular check valve 30 via the bottom of the annular check valve 30, and is screwed with the filter holder 40. So the annular check valve 30 is rotatable relative to the filter holder 40 along the shaft 50. With reference to FIG. 13, in the second embodiment, the shaft 50A is made of a plastic material, is mounted through the annular check valve 30, and is fixed to and combined with the filter holder 40 by ultrasonic welding. With reference to FIG. 14, in the third embodiment, the shaft 50B is mounted through the filter holder 40 from the top of the filter holder 40 and is fixed to the annular check valve 30 by threaded engagement or by ultrasonic welding.

With reference to FIG. 7, since the rotary filter holder assembly 20 comprises the annular check valve 30 being rotatable relative to the filter holder 40, after assembling the filter cartridge 10 with the rotary filter holder assembly 20, a user can rotate the filter cartridge 10 to drive the annular check valve 30 to rotate to the opened position, thereby the inlet channel 42 of the filter holder 40 fluidly communicating with the inlet opening 32 of the annular check valve 30 and the outlet channel 44 of the filter holder 40 fluidly communicating with the outlet opening 34 of the annular check valve 30. Fluid from the external water source flows into the filter cartridge 10 to be filtered by the filter cartridge 10 through the inlet channel 42 of the filter holder 40 and the inlet opening 32 of the annular check valve 30 in sequence. The filtered fluid flows out of the filter unit through the outlet opening 34 of the annular check valve 30 and the outlet channel 44 of the filter holder 40 in sequence.

With reference to FIG. 6, to replace the filter cartridge 10, the user may rotate the filter cartridge 10 to drive the annular check valve 30 to rotate to the closed position, thereby sealing the inlet channel 42 of the filter holder 40 by the sealing pad 35 and to close the outlet channel 44 of the filter holder 40 by the top of the base 31, and then the user may remove the filter cartridge 10 from the rotary filter holder assembly 20. As the inlet channel 42 and the outlet channel 44 of the filter holder 40 are closed by the annular check valve 30 at the same time, the fluid remaining in the inlet channel 42 and the outlet channel 44 is prevented from dripping out of the filter holder 40. Both the inlet channel 42 and the outlet channel 44 can be sealed without leakage.

What is claimed is:

1. A filter unit comprising:
a filter cartridge comprising
a top portion;
a rotary filter holder assembly detachably mounted to the top portion of the filter cartridge and comprising
an annular check valve disposed on the top portion of the filter cartridge, configured to be rotated with the filter cartridge, and comprising
a base disposed on the top portion of the filter cartridge, configured to be rotated with the filter cartridge, and having
a top; and
a bottom;
a neck part extending from the top of the base;
an inlet opening formed in the neck part and fluidly communicating with the filter cartridge;
an outlet opening formed in the top of the base and fluidly communicating with the filter cartridge; and
a sealing pad disposed at a periphery of the neck part and spaced apart from the inlet opening by an angular interval; and
a filter holder disposed on, surrounding, and rotatably connected to the annular check valve, and the filter holder comprising
a top;
a bottom;
an external peripheral surface;
an inlet channel; and
an outlet channel; wherein the annular check valve is configured to rotated relative to
the filter holder to a closed position and an opened position;
when the annular check valve is located at the closed position, the inlet
channel of the filter is sealed by scaling pad and the outlet channel
of the filter holder is closed by the top of the base; and
when the annular check valve is located at opened position, the
inlet channel of the filter holder fluidly communicates with inlet opening of
the annular check valve, and the outlet channel of the filter holder fluidly
communicates with outlet opening of the annular check valve.

2. The filter unit as claimed in claim 1, wherein the annular check valve is connected to the filter holder via a shaft and is rotatable relative to the filter holder along the shaft.

3. The filter unit as claimed in claim 2, wherein
the filter holder comprises a mounting chamber extending upwardly from the bottom of the filter holder;
the inlet channel of the filter holder fluidly communicates with the mounting chamber;
the neck part of the annular check valve extends into the mounting chamber;
the inlet opening of the annular check valve fluidly communicates with the mounting chamber;
the outlet channel of the filter holder is disposed outside of and spaced apart from the mounting chamber, extends upwardly from the bottom of the filter holder and then extends toward the external peripheral surface of the filter holder; and
the sealing pad is made of elastomers, is fixed to the neck part, and tightly abuts against a peripheral surface of the mounting chamber.

4. The filter unit as claimed in claim 3, wherein
the sealing pad has an annular protrusion formed at a side of the sealing pad facing toward the peripheral surface of the mounting chamber, and tightly abuts against the peripheral surface of the mounting chamber; and
when the annular check valve is located at the closed position, the annular protrusion surrounds an outlet port of the inlet channel facing toward the mounting chamber.

5. The filter unit as claimed in claim 4, wherein
the top portion of the filter cartridge comprises a blocking portion including multiple blocking ribs arranged at angular intervals; and
the annular check valve comprises an engagement portion at the bottom of the base of the annular check valve and including multiple engaging notches arranged at angular intervals; and
the multiple blocking ribs respectively extend into and engage with the engaging notches.

6. The filter unit as claimed in claim 5, wherein
the neck part of the annular check valve has a first limited surface and a second limited surface arranged at an angular interval;
the filter holder comprises a limiting block configure to abut against the first limited surface or the second limited surface;
when the limiting block abuts against the first limited surface, the annular check valve is located at the closed position; and
when the limiting block abuts against the second limited surface, the annular check valve is located at the opened position.

7. The filter unit as claimed in claim 6, wherein
a guiding rib is disposed in the outlet port of the inlet channel and has
a top surface inclined downwardly toward the external peripheral surface of the filter holder; and
a bottom surface inclined upwardly toward the external peripheral surface of the filter holder.

8. The filter unit as claimed in claim 1, wherein
the rotary filter holder assembly comprises a closing pad made of elastomers and fixed to the bottom of the filter holder; and
when the annular check valve is at the closed position, the outlet opening of the annular check valve is directly below the closing pad and is sealed by the closing pad.

9. The filter unit as claimed in claim 2, wherein
the rotary filter holder assembly comprises a closing pad made of elastomers and fixed to the bottom of the filter holder; and
when the annular check valve is at the closed position, the outlet opening of the annular check valve is directly below the closing pad and is sealed by the closing pad.

10. The filter unit as claimed in claim 3, wherein
the rotary filter holder assembly comprises a closing pad made of elastomers and fixed to the bottom of the filter holder; and
when the annular check valve is at the closed position, the outlet opening of the annular check valve is directly below the closing pad and is sealed by the closing pad.

11. The filter unit as claimed in claim 4, wherein
the rotary filter holder assembly comprises a closing pad made of elastomers and fixed to the bottom of the filter holder; and
when the annular check valve is at the closed position, the outlet opening of the annular check valve is directly below the closing pad and is sealed by the closing pad.

12. The filter unit as claimed in claim 5, wherein
the rotary filter holder assembly comprises a closing pad made of elastomers and fixed to the bottom of the filter holder; and
when the annular check valve is at the closed position, the outlet opening of the annular check valve is directly below the closing pad and is sealed by the closing pad.

13. The filter unit as claimed in claim 6, wherein
the rotary filter holder assembly comprises a closing pad made of elastomers and fixed to the bottom of the filter holder; and
when the annular check valve is at the closed position, the outlet opening of the annular check valve is directly below the closing pad and is sealed by the closing pad.

14. The filter unit as claimed in claim 7, wherein
the rotary filter holder assembly comprises a closing pad made of elastomers and fixed to the bottom of the filter holder; and
when the annular check valve is at the closed position, the outlet opening of the annular check valve is directly below the closing pad and is sealed by the closing pad.
